(19) United States
(12) Patent Application Publication
(10) Pub. No.: US 2025/0384138 A1
(43) Pub. Date: Dec. 18, 2025

(54) GENERATING RUNNABLE SCRIPTS FROM VULNERABILITY CHAINS

(71) Applicant: International Business Machines Corporation, Armonk, NY (US)

(72) Inventors: Karen Louise Jude, Winchester (GB); Richard Howe, Mebane, NC (US); Nikki Elyse Robinson, Davidsonville, MD (US); Kimberly Hancock, Brookfield, CT (US)

(21) Appl. No.: 18/742,832

(22) Filed: Jun. 13, 2024

(51) Int. Cl. G06F 21/57

(52) U.S. Cl. CPC G06F 21/577

(57) ABSTRACT

A computer-implemented method, according to one approach, includes: causing a network entity scanner to scan an Information Technology (IT) environment and collect information associated with the IT environment. A chained vulnerability identifier identifies vulnerability chains based at least in part on the IT environment information. A foundation model builds a new vulnerability chain model that is trained on the IT environment information and the vulnerability chains. Moreover, a visualizer converts the new vulnerability chain model into a visualization of the IT environment and identified exploit paths. The visualization is further transmitted to a user interface.

### BACKGROUND

The present invention relates to machine learning models, and more specifically, this invention relates to generating runnable scripts from vulnerability chains.

Data production continues to increase as computing power advances. For instance, the rise of smart enterprise endpoints has led to large amounts of data being generated at remote locations. Data production will only further increase with the growth of 5G networks and an increased number of connected mobile devices. As data production increases, so does the overhead associated with processing the larger amounts of data. Processing overhead is further increased when dealing with unstructured data and as different types of information are involved. For example, video and audio data may be combined in a pool of unstructured data, which results in longer processing times.

While cloud computing has been implemented in some conventional systems in an effort to improve the ability to process this increasing amount of data, moving sensitive workloads to the cloud exposes them to security risks. For example, the process of moving certain workloads to cloud for computation efficiency assumes (e.g., requires) the cloud and corresponding system to be secure. However, conventional directory environments are often large, legacy in nature, and have grown organically without the benefit of formal security architecture guidance or configuration best practices. Consequently, these conventional environments often have a significant number of vulnerabilities which would have a substantial impact if successfully exploited.

Although some existing vulnerabilities can be mitigated by applying recommended security configurations, this often results in degradation of functionality and/or performance in addition to failing to mitigate other severe vulnerabilities. Architectural security recommendations, which may mitigate some of the more severe issues, are usually not economically viable as they involve re-architecting and rebuilding an entire, often operation-critical, IT environment.

### SUMMARY

A computer-implemented method (CIM), according to one approach, includes: causing a network entity scanner to scan an Information Technology (IT) environment and collect information associated with the IT environment. A chained vulnerability identifier identifies vulnerability chains based at least in part on the IT environment information. A foundation model builds a new vulnerability chain model that is trained on the IT environment information and the vulnerability chains. Moreover, a visualizer converts the new vulnerability chain model into a visualization of the IT environment and identified exploit paths. The visualization is further transmitted to a user interface.

A computer program product (CPP), according to another approach, includes: a set of one or more computer-readable storage media, and program instructions. The program instructions are collectively stored in the set of one or more storage media, and are for causing a processor set to perform the foregoing CIM.

A computer system (CS), according to yet another approach, includes: a processor set, and a set of one or more computer-readable storage media. The CS also includes program instructions that are collectively stored in the set of one or more storage media, and are for causing the processor set to perform the foregoing CIM.

Other aspects and implementations of the present invention will become apparent from the following detailed description, which, when taken in conjunction with the drawings, illustrate by way of example the principles of the invention.

### BRIEF DESCRIPTION OF THE DRAWINGS

FIG. 1 is a diagram of a computing environment, in accordance with one approach.

FIG. 2 is a representational view of a distributed system, in accordance with one approach.

FIG. 3A is a flowchart of a method, in accordance with one approach.

FIG. 3B is a flowchart of sub-operations performed in response to one of the operations in the method of FIG. 3A, in accordance with one approach.

FIG. 3C is a flowchart of sub-operations performed in response to one of the operations in the method of FIG. 3A, in accordance with another approach.

FIG. 4A is a partial representational view of a distributed system, in accordance with one approach.

FIG. 4B is a partial representational view of a new vulnerability chain model, in accordance with an in-use example.

FIG. 5 is a is an example block diagram illustrating the primary operational components of a vulnerability chain modeling and prioritization (VCMAP) engine, in accordance with one approach.

### DETAILED DESCRIPTION

The following description is made for the purpose of illustrating the general principles of the present invention and is not meant to limit the inventive concepts claimed herein. Further, particular features described herein can be used in combination with other described features in each of the various possible combinations and permutations.

Unless otherwise specifically defined herein, all terms are to be given their broadest possible interpretation including meanings implied from the specification as well as meanings understood by those skilled in the art and/or as defined in dictionaries, treatises, etc.

It must also be noted that, as used in the specification and the appended claims, the singular forms “a,” “an” and “the” include plural referents unless otherwise specified. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The following description discloses several preferred approaches of systems, methods and computer program products for building and training foundation models to scan distributed systems and identify previously unknown attack paths and/or predict likely future attack paths in the systems to develop vulnerability chains. The attack paths identified by approaches herein may thereby allow for preventative steps to be taken to secure a corresponding environment, e.g., before experiencing a predicted attack. Approaches herein are also desirably able to assist in securing an environment without affecting the functionality of the system. This is achieved at least in part by developing (e.g., building and training) foundation models that are able to automatically generate runnable exploit scripts that incorporate the identified exploit paths, e.g., as will be described in further detail below.

In one general approach, a CIM includes: causing a network entity scanner to scan an Information Technology (IT) environment and collect information associated with the IT environment. A chained vulnerability identifier identifies vulnerability chains based at least in part on the IT environment information. A foundation model builds a new vulnerability chain model that is trained on the IT environment information and the vulnerability chains. Moreover, a visualizer converts the new vulnerability chain model into a visualization of the IT environment and identified exploit paths. The visualization is further transmitted to a user interface.

In another general approach, a CPP includes: a set of one or more computer-readable storage media, and program instructions. The program instructions are collectively stored in the set of one or more storage media, and are for causing a processor set to perform the foregoing CIM.

In yet another general approach, a CS includes: a processor set, and a set of one or more computer-readable storage media. The CS also includes program instructions that are collectively stored in the set of one or more storage media, and are for causing the processor set to perform the foregoing CIM.

Various aspects of the present disclosure are described by narrative text, flowcharts, block diagrams of computer systems and/or block diagrams of the machine logic included in computer program product (CPP) approaches. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product approach (“CPP approach” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

Computing environment 100 contains an example of an environment for the execution of at least some of the computer code involved in performing the inventive methods, such as improved vulnerability chain code at block 150 for building and training foundation models to scan distributed systems and identify previously unknown attack paths and/or predict likely future attack paths in the systems to develop vulnerability chains, in accordance with one approach. This is achieved at least in part by developing (e.g., building and training) foundation models that are able to automatically generate runnable exploit scripts that incorporate the identified attack paths, e.g., as will be described in further detail below.

In addition to block 150, computing environment 100 includes, for example, computer 101, wide area network (WAN) 102, end user device (EUD) 103, remote server 104, public cloud 105, and private cloud 106. In this approach, computer 101 includes processor set 110 (including processing circuitry 120 and cache 121), communication fabric 111, volatile memory 112, persistent storage 113 (including operating system 122 and block 150, as identified above), peripheral device set 114 (including user interface (UI) device set 123, storage 124, and Internet of Things (IOT) sensor set 125), and network module 115. Remote server 104 includes remote database 130. Public cloud 105 includes gateway 140, cloud orchestration module 141, host physical machine set 142, virtual machine set 143, and container set 144.

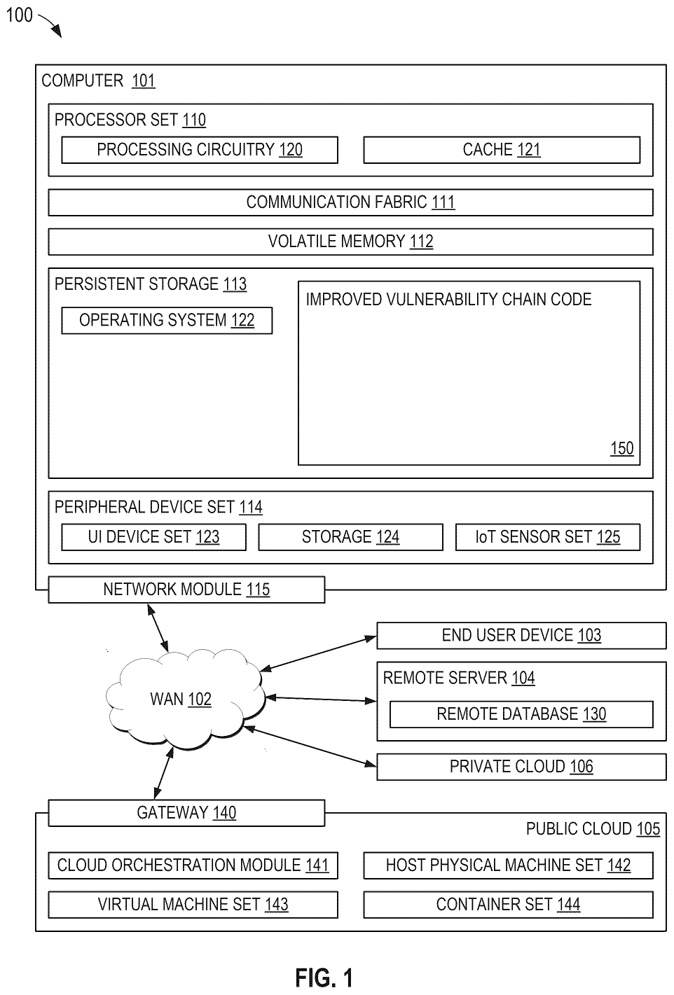

COMPUTER 101 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 130. As is well understood in the art of computer technology, and depending upon the technology, performance of a computer-implemented method may be distributed among multiple computers and/or between multiple locations. On the other hand, in this presentation of computing environment 100, detailed discussion is focused on a single computer, specifically computer 101, to keep the presentation as simple as possible. Computer 101 may be located in a cloud, even though it is not shown in a cloud in FIG. 1. On the other hand, computer 101 is not required to be in a cloud except to any extent as may be affirmatively indicated.

PROCESSOR SET 110 includes one, or more, computer processors of any type now known or to be developed in the future. Processing circuitry 120 may be distributed over multiple packages, for example, multiple, coordinated integrated circuit chips. Processing circuitry 120 may implement multiple processor threads and/or multiple processor cores. Cache 121 is memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the cache for the processor set may be located “off chip.” In some computing environments, processor set 110 may be designed for working with qubits and performing quantum computing.

Computer readable program instructions are typically loaded onto computer 101 to cause a series of operational steps to be performed by processor set 110 of computer 101 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 121 and the other storage media discussed below. The program instructions, and associated data, are accessed by processor set 110 to control and direct performance of the inventive methods. In computing environment 100, at least some of the instructions for performing the inventive methods may be stored in block 150 in persistent storage 113.

COMMUNICATION FABRIC 111 is the signal conduction path that allows the various components of computer 101 to communicate with each other. Typically, this fabric is made of switches and electrically conductive paths, such as the switches and electrically conductive paths that make up buses, bridges, physical input/output ports and the like. Other types of signal communication paths may be used, such as fiber optic communication paths and/or wireless communication paths.

VOLATILE MEMORY 112 is any type of volatile memory now known or to be developed in the future. Examples include dynamic type random access memory (RAM) or static type RAM. Typically, volatile memory 112 is characterized by random access, but this is not required unless affirmatively indicated. In computer 101, the volatile memory 112 is located in a single package and is internal to computer 101, but, alternatively or additionally, the volatile memory may be distributed over multiple packages and/or located externally with respect to computer 101.

PERSISTENT STORAGE 113 is any form of non-volatile storage for computers that is now known or to be developed in the future. The non-volatility of this storage means that the stored data is maintained regardless of whether power is being supplied to computer 101 and/or directly to persistent storage 113. Persistent storage 113 may be a read only memory (ROM), but typically at least a portion of the persistent storage allows writing of data, deletion of data and re-writing of data. Some familiar forms of persistent storage include magnetic disks and solid state storage devices. Operating system 122 may take several forms, such as various known proprietary operating systems or open source Portable Operating System Interface-type operating systems that employ a kernel. The code included in block 150 typically includes at least some of the computer code involved in performing the inventive methods.

PERIPHERAL DEVICE SET 114 includes the set of peripheral devices of computer 101. Data communication connections between the peripheral devices and the other components of computer 101 may be implemented in various ways, such as Bluetooth connections, Near-Field Communication (NFC) connections, connections made by cables (such as universal serial bus (USB) type cables), insertion-type connections (for example, secure digital (SD) card), connections made through local area communication networks and even connections made through wide area networks such as the internet. In various approaches, UI device set 123 may include components such as a display screen, speaker, microphone, wearable devices (such as goggles and smart watches), keyboard, mouse, printer, touchpad, game controllers, and haptic devices. Storage 124 is external storage, such as an external hard drive, or insertable storage, such as an SD card. Storage 124 may be persistent and/or volatile. In some approaches, storage 124 may take the form of a quantum computing storage device for storing data in the form of qubits. In approaches where computer 101 is required to have a large amount of storage (for example, where computer 101 locally stores and manages a large database) then this storage may be provided by peripheral storage devices designed for storing very large amounts of data, such as a storage area network (SAN) that is shared by multiple, geographically distributed computers. IoT sensor set 125 is made up of sensors that can be used in Internet of Things applications. For example, one sensor may be a thermometer and another sensor may be a motion detector.

NETWORK MODULE 115 is the collection of computer software, hardware, and firmware that allows computer 101 to communicate with other computers through WAN 102. Network module 115 may include hardware, such as modems or Wi-Fi signal transceivers, software for packetizing and/or de-packetizing data for communication network transmission, and/or web browser software for communicating data over the internet. In some approaches, network control functions and network forwarding functions of network module 115 are performed on the same physical hardware device. In other approaches (for example, approaches that utilize software-defined networking (SDN)), the control functions and the forwarding functions of network module 115 are performed on physically separate devices, such that the control functions manage several different network hardware devices. Computer readable program instructions for performing the inventive methods can typically be downloaded to computer 101 from an external computer or external storage device through a network adapter card or network interface included in network module 115.

WAN 102 is any wide area network (for example, the internet) capable of communicating computer data over non-local distances by any technology for communicating computer data, now known or to be developed in the future. In some approaches, the WAN 102 may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

END USER DEVICE (EUD) 103 is any computer system that is used and controlled by an end user (for example, a customer of an enterprise that operates computer 101), and may take any of the forms discussed above in connection with computer 101. EUD 103 typically receives helpful and useful data from the operations of computer 101. For example, in a hypothetical case where computer 101 is designed to provide a recommendation to an end user, this recommendation would typically be communicated from network module 115 of computer 101 through WAN 102 to EUD 103. In this way, EUD 103 can display, or otherwise present, the recommendation to an end user. In some approaches, EUD 103 may be a client device, such as thin client, heavy client, mainframe computer, desktop computer and so on.

REMOTE SERVER 104 is any computer system that serves at least some data and/or functionality to computer 101. Remote server 104 may be controlled and used by the same entity that operates computer 101. Remote server 104 represents the machine(s) that collect and store helpful and useful data for use by other computers, such as computer 101. For example, in a hypothetical case where computer 101 is designed and programmed to provide a recommendation based on historical data, then this historical data may be provided to computer 101 from remote database 130 of remote server 104.

PUBLIC CLOUD 105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 105 is performed by the computer hardware and/or software of cloud orchestration module 141. The computing resources provided by public cloud 105 are typically implemented by virtual computing environments that run on various computers making up the computers of host physical machine set 142, which is the universe of physical computers in and/or available to public cloud 105. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 141 manages the transfer and storage of images, deploys new instantiations of VCEs and manages active instantiations of VCE deployments. Gateway 140 is the collection of computer software, hardware, and firmware that allows public cloud 105 to communicate through WAN 102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

PRIVATE CLOUD 106 is similar to public cloud 105, except that the computing resources are only available for use by a single enterprise. While private cloud 106 is depicted as being in communication with WAN 102, in other approaches a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this approach, public cloud 105 and private cloud 106 are both part of a larger hybrid cloud.

CLOUD COMPUTING SERVICES AND/OR MICROSERVICES (not separately shown in FIG. 1): private and public clouds 106 are programmed and configured to deliver cloud computing services and/or microservices (unless otherwise indicated, the word “microservices” shall be interpreted as inclusive of larger “services” regardless of size). Cloud services are infrastructure, platforms, or software that are typically hosted by third-party providers and made available to users through the internet. Cloud services facilitate the flow of user data from front-end clients (for example, user-side servers, tablets, desktops, laptops), through the internet, to the provider's systems, and back. In some approaches, cloud services may be configured and orchestrated according to as “as a service” technology paradigm where something is being presented to an internal or external customer in the form of a cloud computing service. As-a-Service offerings typically provide endpoints with which various customers interface. These endpoints are typically based on a set of APIs. One category of as-a-service offering is Platform as a Service (PaaS), where a service provider provisions, instantiates, runs, and manages a modular bundle of code that customers can use to instantiate a computing platform and one or more applications, without the complexity of building and maintaining the infrastructure typically associated with these things. Another category is Software as a Service (SaaS) where software is centrally hosted and allocated on a subscription basis. SaaS is also known as on-demand software, web-based software, or web-hosted software. Four technological sub-fields involved in cloud services are: deployment, integration, on demand, and virtual private networks.

In some aspects, a system according to various approaches may include a processor and logic integrated with and/or executable by the processor, the logic being configured to perform one or more of the process steps recited herein. The processor may be of any configuration as described herein, such as a discrete processor or a processing circuit that includes many components such as processing hardware, memory, I/O interfaces, etc. By integrated with, what is meant is that the processor has logic embedded therewith as hardware logic, such as an application specific integrated circuit (ASIC), a FPGA, etc. By executable by the processor, what is meant is that the logic is hardware logic; software logic such as firmware, part of an operating system, part of an application program; etc., or some combination of hardware and software logic that is accessible by the processor and configured to cause the processor to perform some functionality upon execution by the processor. Software logic may be stored on local and/or remote memory of any memory type, as known in the art. Any processor known in the art may be used, such as a software processor module and/or a hardware processor such as an ASIC, a FPGA, a central processing unit (CPU), an integrated circuit (IC), a graphics processing unit (GPU), etc.

Of course, this logic may be implemented as a method on any device and/or system or as a computer program product, according to various approaches.

As noted above, data production has continued to increase, particularly as computing power and the use of IoT devices continue to advance. For instance, the rise of smart enterprise endpoints has led to large amounts of data being generated at remote locations. Data production will only further increase with the growth of 5G networks and an increased number of connected mobile devices.

While cloud computing has been implemented in some conventional systems in an effort to improve the ability to process this increasing amount of data, moving sensitive workloads to the cloud exposes them to security risks. For example, the process of moving certain workloads to cloud for computation efficiency assumes (e.g., requires) the cloud and corresponding system to be secure. However, conventional directory environments are often large, legacy in nature, and have grown organically without the benefit of formal security architecture guidance or configuration best practices. Consequently, these conventional environments often have a significant number of vulnerabilities which would have a substantial impact if successfully exploited.

Although some existing vulnerabilities can be mitigated by applying recommended security configurations, this often results in degradation of functionality and/or performance in addition to failing to mitigate other severe vulnerabilities. Architectural security recommendations, which may mitigate some of the more severe issues, are usually not economically viable as they involve re-architecting and rebuilding an entire, often operation-critical, IT environment. The lack of such a solution means that system administrators are unable to keep up with threat actors applying AI based techniques to prioritize and automate nefarious workloads.

In sharp contrast to the foregoing shortcomings experienced by conventional environments, approaches herein are able to build and train foundation models to scan distributed systems and identify (e.g., find) previously unknown attack paths and/or predict likely future attack paths in IT environments. With respect to the present description, “attack paths” or “exploit paths” is intended to refer to vulnerability chains that a given environment (e.g., system) presents. The identified attack paths may thereby allow for steps to be taken in order to secure an environment in advance of an attack. Approaches herein are also able to successfully assist in securing an environment without affecting the functionality of the system.

Some approaches, the identified attack paths may be evaluated by additional models (e.g., foundation models) that are trained to create scripts that may be run to exploit the vulnerability chains in the attack paths. Approaches could also produce risk scores (e.g., Common Vulnerability Scoring System (CVSS), Exploit Prediction Scoring System (EPSS), etc.) for each of the vulnerabilities. In some approaches the risk scores may be generated along with respective difficulty ratings that summarize the script creation process. Risk scores and/or difficulty ratings may also be used to automate testing of the identified vulnerabilities.

It follows that approaches herein use foundation models that have been trained to write exploit scripts in any desired scripting language (e.g., PYTHON, BASH, etc.) based on identified attack paths. In other words, approaches herein are able to perform script generation using artificial intelligence (AI) based models (e.g., foundation models) that have been trained to exploit a vulnerability chain in a specific IT environment.

This differs significantly from code writing tools which merely function as developer productivity tools for security. These tools can only detect and correct security flaws in human written code, but they do not detect chained vulnerabilities in an existing system, or generate exploit scrips for these chains, much less assign a difficulty rating as described herein. Again, in sharp contrast, approaches herein are able to automate the process of identifying new and novel vulnerability chains which have not previously been classified, and generating running exploit scripts for the identified chains. Some approaches even generate difficulty ratings for the script productions. This is achieved by focusing on modeling a vulnerability chain from the perspective of Common Vulnerabilities and Exposures (CVE) severity, as well as exploitability in the respective IT environment.

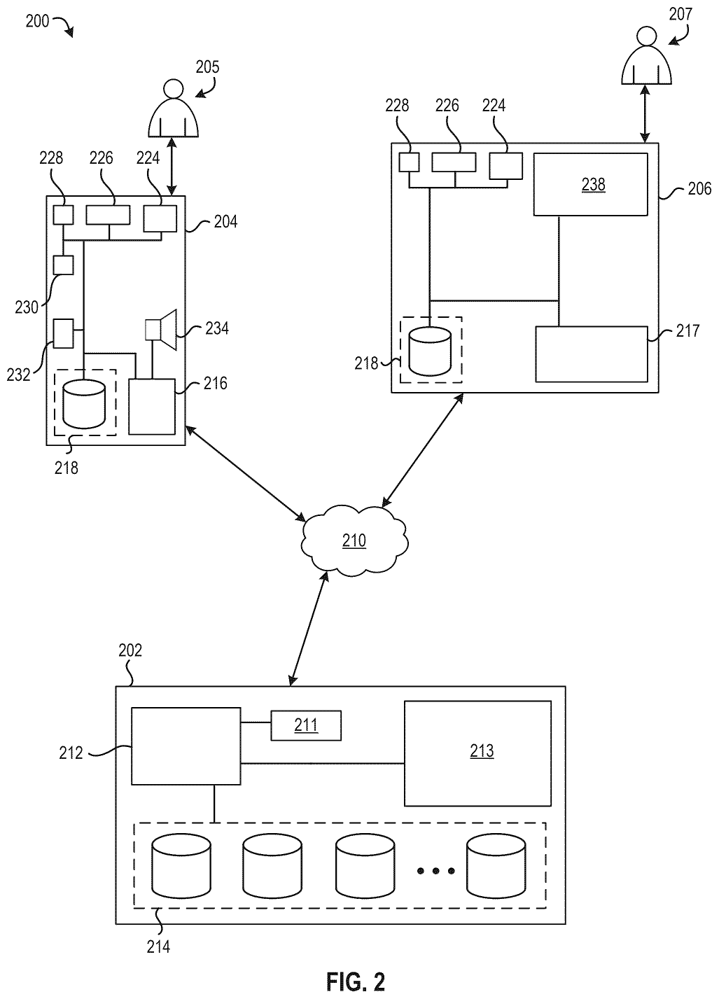

Looking now to FIG. 2, a system 200 having a distributed architecture is illustrated in accordance with one approach. As an option, the present system 200 may be implemented in conjunction with features from any other approach listed herein, such as those described with reference to the other FIGS., such as FIG. 1. However, such system 200 and others presented herein may be used in various applications and/or in permutations which may or may not be specifically described in the illustrative approaches or implementations listed herein. Further, the system 200 presented herein may be used in any desired environment. Thus FIG. 2 (and the other FIGS.) may be deemed to include any possible permutation.

As shown, the system 200 includes a central server 202 that is connected to a user device 204, and edge node 206 accessible to the user 205 and administrator 207, respectively. The central server 202, user device 204, and edge node 206 are each connected to a network 210, and may thereby be positioned in different geographical locations. The network 210 may be of any type, e.g., depending on the desired approach. For instance, in some approaches the network 210 is a WAN, e.g., such as the Internet. However, an illustrative list of other network types which network 210 may implement includes, but is not limited to, a LAN, a PSTN, a SAN, an internal telephone network, etc. As a result, any desired information, data, commands, instructions, responses, requests, etc. may be sent between user device 204, edge node 206, and/or central server 202, regardless of the amount of separation which exists therebetween, e.g., despite being positioned at different geographical locations.

However, it should be noted that two or more of the user device 204, edge node 206, and central server 202 may be connected differently depending on the approach. According to an example, which is in no way intended to limit the invention, two servers (e.g., nodes) may be located relatively close to each other and connected by a wired connection, e.g., a cable, a fiber-optic link, a wire, etc.; etc., or any other type of connection which would be apparent to one skilled in the art after reading the present description.

The terms “user” and “administrator” are in no way intended to be limiting either. For instance, while users and administrators may be described as being individuals in various implementations herein, a user and/or an administrator may be an application, an organization, a preset process, etc. The use of “data” and “information” herein is in no way intended to be limiting either, and may include any desired type of details, e.g., depending on the type of operating system implemented on the user device 204, edge node 206, and/or central server 202. For example, video data, audio data, sensor data, images, etc. may be sent to the central server 202 from user device 204 and/or edge node 206 for processing using one or more AI based models, e.g., such as a foundation model and/or machine learning models.

With continued reference to FIG. 2, the central server 202 includes a large (e.g., robust) processor 212 coupled to a cache 211, an AI module 213, and a data storage array 214 having a relatively high storage capacity. As noted above, the AI module 213 may include any desired number and/or type of AI based models. In preferred approaches, the AI module 213 and/or processor 212 includes foundation models that have been trained using information corresponding to operation of an Information Technology (IT) environment (e.g., system). With respect to the present description, the information may include any desired type(s) of details that are correlated with how a given IT environment performs over time in a variety of different situations. In some approaches, the foundation model is trained using system log information, e.g., such as startup messages, system changes, errors and warnings, etc.

It follows that the operation data from an IT environment may be received from a source that is in and/or connected to the system 200. For example, operation data may be received from a Security Incident and Event Management (SIEM) system, computational devices, operating systems, etc. In some approaches, the operation data is received from user device 204, edge node 206, or any other source that is connected to the network 210. Moreover, the received operation data is preferably stored in a repository (e.g., data lake) that feeds into a data trainer configured to generate and train desired foundation models using the available operation data, e.g., as will be described in further detail below.

With continued reference to FIG. 2, user device 204 includes a processor 216 which is coupled to memory 218. The user device 204 may receive inputs from, and interface with, user 205. For instance, the user 205 may input information using one or more of: a display screen 224, keys of a computer keyboard 226, a computer mouse 228, a microphone 230, and a camera 232. The processor 216 may thereby be configured to receive inputs (e.g., text, sounds, images, motion data, etc.) from any of these components as entered by the user 205. These inputs typically correspond to information presented on the display screen 224 while the entries were received. Moreover, the inputs received from the keyboard 226 and computer mouse 228 may impact the information shown on display screen 224, data stored in memory 218, information collected from the microphone 230 and/or camera 232, status of an operating system being implemented by processor 216, etc. The electronic device 204 also includes a speaker 234 which may be used to play (e.g., project) audio signals for the user 205 to hear.

Some data may be received from user 205 for storage and/or evaluation using AI module 213. For instance, system log information may be received as a result of the user 205 using one or more applications, software programs, temporary communication connections, etc. running on the user device 204. For example, the user 205 may upload data for storage at the data storage array 214 and evaluation using processor 212 and/or AI module 213 of central server 202. As a result, the data may be evaluated and processed.

Looking now to the edge node 206 of FIG. 2, some of the components included therein may be the same or similar to those included in user device 204, some of which have been given corresponding numbering. For instance, controller 217 is coupled to memory 218, a display screen 224, keys of a computer keyboard 226, and a computer mouse 228. Additionally, the controller 217 is coupled to an AI module 238. As described above with respect to AI module 213, the AI module 238 may include any desired number and/or type of machine learning models. It follows that AI module 238 may implement similar, the same, or different characteristics as AI module 213 in central server 202.

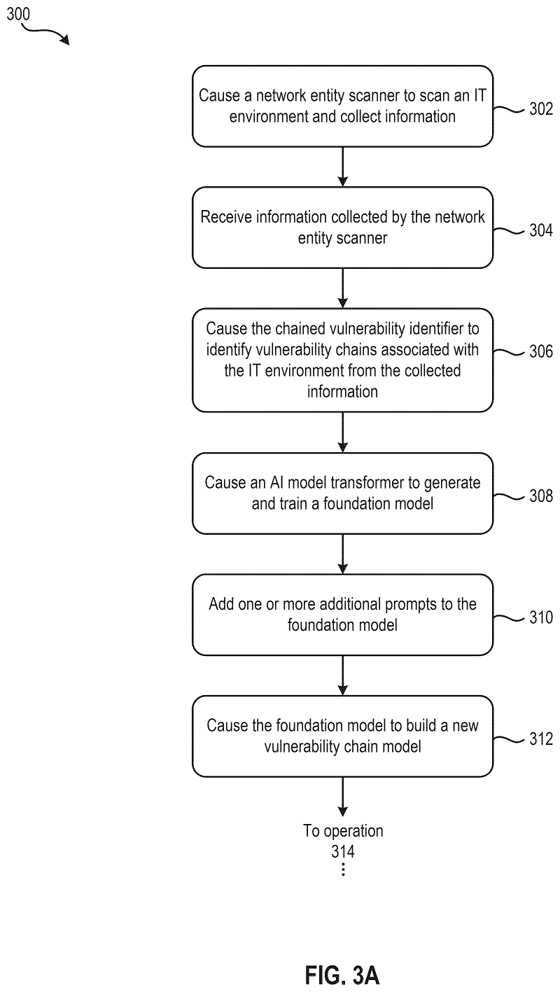

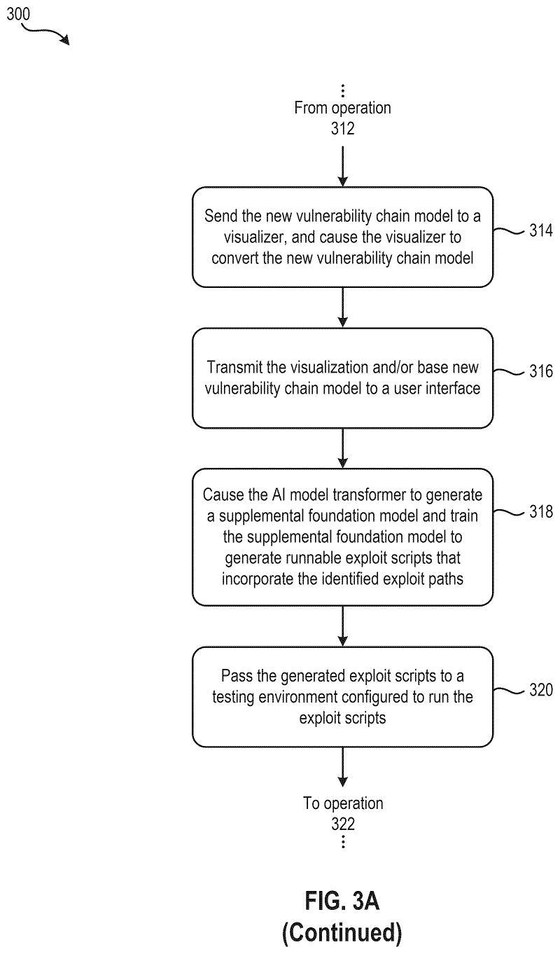

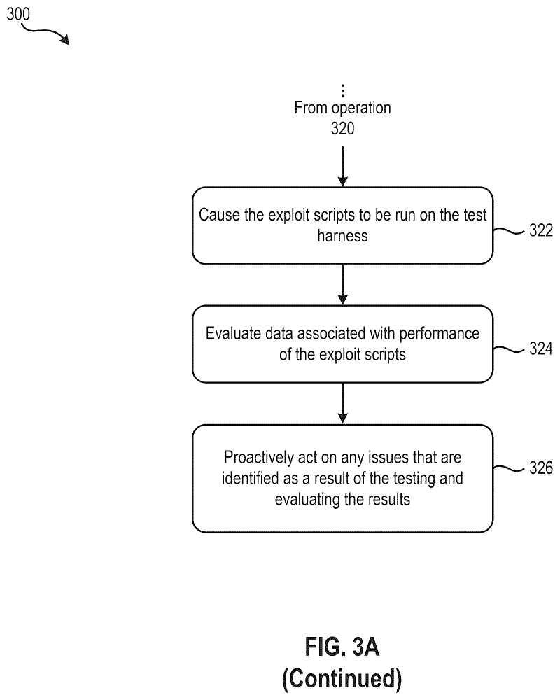

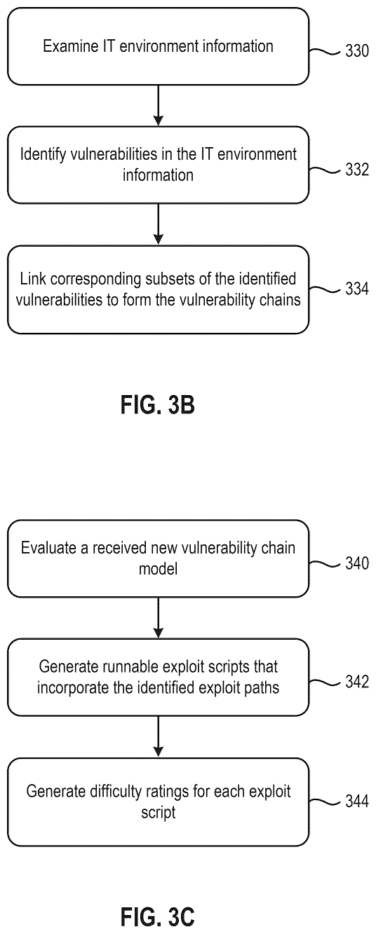

Looking now to FIG. 3A, a flowchart of a computer-implemented method 300 for building and training foundation models to scan distributed systems and identify previously unknown attack paths and/or predict likely future attack paths in the systems is illustrated in accordance with one approach. The identified attack paths may thereby allow for preventative steps to be taken to secure an environment, e.g., before experiencing a predicted attack. The operations of method 300 are also desirably able to assist in securing an environment without affecting the functionality of the system. This is achieved at least in part by developing (e.g., building and training) foundation models that are able to automatically generate runnable exploit scripts that incorporate the identified exploit paths. Moreover, method 300 may be performed in accordance with the present invention in any of the environments depicted in FIGS. 1-2, among others, in various approaches.

Of course, more or less operations than those specifically described in FIG. 3A may be included in method 300, as would be understood by one of skill in the art upon reading the present descriptions. Each of the steps of the method 300 may be performed by any suitable component of the operating environment using known techniques and/or techniques that would become readily apparent to one skilled in the art upon reading the present disclosure. In some approaches, one or more processors located at a central server of a distributed system (e.g., see processor 212 of FIG. 2 above) and/or an AI based module (e.g., see AI based module 213 of FIG. 2 above) may be used to perform one or more of the operations in method 300. In another approach, one or more processors located at an edge server (e.g., see controller 217 of FIG. 2 above) and/or an AI based module (e.g., see AI based module 238 of FIG. 2 above) may be used to perform one or more of the operations in method 300.

Accordingly, in some approaches at least some of the operations of method 300 may be performed by an AI model that is trained using a predetermined training set of data. For example, in some approaches, various of the operations noted above may be deployed in a trained state of a trained AI model. Training of the AI model, in some approaches, may be performed by applying a predetermined training data set to learn how to scan distributed systems and identify previously unknown attack paths and/or predict likely future attack paths in the systems. Predetermined training data sets may also be applied to learn how to automatically generate runnable exploit scripts that incorporate the identified attack paths. Initial training may include reward feedback that may, in some approaches, be implemented using a subject matter expert (SME) that generally understands vulnerability chains. However, to prevent costs associated with relying on manual actions of a SME, in another approach, reward feedback may be implemented using techniques for training a BERT model, as would become apparent to one skilled in the art after reading the present disclosure. Once a determination is made that the AI model achieves a redeemed threshold of accuracy of performing the operations described herein during this training, a decision that the model is trained and ready to deploy for performing at least some of the techniques and/or operations of method 300 may be performed. In some further approaches, the AI model may be a neuromyotonic AI model that may improve performance of computer devices in an infrastructure associated with attack paths and vulnerability chains, because the neuromyotonic AI model may not need an SME and/or iteratively applied training with reward feedback in order to accurately perform operations described herein. Instead, the neuromyotonic AI model is configured to itself make determinations described in operations herein. Weight values may, in some approaches, be used by the AI reasoning model to collect and analyze information and/or feedback potentially received from an IT environment. Such an AI model ensures that previously unknown attack paths are identified and future attack paths in the systems are predicted. The AI model(s) may also ensure that runnable exploit scripts that incorporate the identified attack paths are automatically generated and tested, where the scale of such analysis and determinations would not otherwise be feasible for a human to perform. This is because humans are not able to efficiently do so, and would otherwise incorporate processing delays and errors in the process of performing the approaches included herein. Accordingly, management of operations described herein is not able to be achieved by human manual actions.

Moreover, in various approaches, the method 300 may be partially or entirely performed by a controller, a processor, etc., or some other device having one or more processors therein. The processor, e.g., processing circuit(s), chip(s), and/or module(s) implemented in hardware and/or software, and preferably having at least one hardware component may be utilized in any device to perform one or more steps of the method 300. Illustrative processors include, but are not limited to, a central processing unit (CPU), an application specific integrated circuit (ASIC), a field programmable gate array (FPGA), etc., combinations thereof, or any other suitable computing device known in the art.

Again, FIG. 3A illustrates the formation, training, and application of foundation models and/or tailored machine learning models based on information corresponding to a system (e.g., performance data, configuration information, user preferences, etc.). Accordingly, operation 302 includes causing a network entity scanner to scan an Information Technology (IT) environment and collect information associated with the IT environment. As noted above, the information that is collected may include performance data, configuration information, user preferences, etc. In some approaches, the network entity scanner ingests the vulnerability and other identifiable information for each asset associated with a given network and application environment. Thus, vulnerability and/or asset data can be provided as an ingestible report via exports from a vulnerability or port scan, or scans can be initiated from the system itself.

It should also be noted that “causing” as used herein is intended to include sending any instructions, commands, requests, executable code, etc., to the target location (e.g., component). Thus, “causing” the network entity scanner to scan the IT environment in operation 302 may include sending instructions, commands, requests, executable code, etc., to the network entity scanner for implementation, e.g., as would be appreciated by one skilled in the art after reading the present description.

Proceeding to operation 304, the information collected by the network entity scanner is received by the processor performing the operations of method 300. Moreover, operation 306 includes sending the collected information to a chained vulnerability identifier, in addition to causing the chained vulnerability identifier to identify vulnerability chains associated with the IT environment.

Referring momentarily to FIG. 3B, exemplary sub-operations of identifying vulnerability chains are illustrated in accordance with one approach. It follows that one or more of these sub-operations may be performed by the chained vulnerability identifier in response to operation 306 of FIG. 3A. However, it should be noted that the sub-operations of FIG. 3B are illustrated in accordance with one approach which is in no way intended to be limiting.

As shown, sub-operation 330 includes examining the IT environment information, while sub-operation 332 includes identifying vulnerabilities in the IT environment information. One or more trained AI based models (e.g., foundation models) may be used to examine the received information and identify patterns that convey information about the corresponding IT environment.

It follows that the vulnerability chains are identified based at least in part on the IT environment information collected by the network entity scanner. The chained vulnerability identifier is preferably configured to enumerate and prioritize the severity of existing vulnerability chains. To do this, the chained vulnerability identifier examines the vulnerabilities, and based on their characteristics, subsets of those vulnerabilities will be “linked” together to form vulnerability chains. Vulnerability chains can further be prioritized to show appeal of exploitation from the perspective of a bad actor. Accordingly, sub-operation 334 further includes linking corresponding subsets of the identified vulnerabilities to form the vulnerability chains.

Returning now to FIG. 3A, method 300 advances from operation 306 to operation 308. There, operation 308 includes causing an AI model transformer to generate a foundation model and train the foundation model using the IT environment information collected by the network entity scanner. The foundation model is also preferably trained using the vulnerability chains identified by the chained vulnerability identifier. The trained foundation model may thereby be configured to produce an output that represents the relationships between the various vulnerability chains, e.g., see operation 312 below.

According to some approaches, the AI model transformer includes a data trainer. The data trainer may be used to aggregate data from a variety of different data sources and convert them into a desired system (e.g., format). The data trainer may also be used to actually train one or more models using the ingested data. Data sources that may be used by the data trainer to build one or more foundation models include, but are in no way limited to, The Adversarial Tactics, Techniques, and Common Knowledge (MITRE Att&ck) Frameworks, CVE databases, knowledge of a given IT environment, etc. In some approaches the data trainer outputs a vulnerability chain model in the form of a graph showing the already classified attack paths with new and novel paths added by the trained foundation model. The vulnerability chain model may be combined with a relative likelihood of exploit weighting based on vulnerabilities of the system.

In some approaches, the data trainer may be used to actually build foundation models and perform the analysis of new vulnerability chains using said foundation models. For instance, the data trainer may ingest data from a data lake (e.g., repository of training data) and perform an inference on the ingested data. By inferencing the ingested data, the data trainer is able to develop an understanding of existing known vulnerability chains and general info about the IT system being evaluated (e.g., scanned). Initially this may be considered ‘chain of thought’ prompting that may be initiated by users to increase the accuracy of model output. It follows that the models analyze the specifics of the IT environment scanned by the network entity scanner and the chained vulnerability identifier to work out the next likely steps an attacker may take, e.g., as would be appreciated by one skilled in the art after reading the present description.

In some approaches, the new foundation model that is built and trained may be specialized for identification of new vulnerability chains that exist in a specific type of IT environment. Some approaches may use known generative AI models to (e.g., OpenAI ChatGPT) to produce some basic reasoning results from the standard LLM. These results could thereby be used as a starting point for developing the foundation model as described above, in some approaches. However, it is preferred that foundation models herein are built as a result of accessing quality data, e.g., that may be available in a repository. In approaches where information associated with a given IT environment is assessed, already known vulnerability chains and other information (e.g., associated with zero day exploits) may thereby be added as prompts.

It is also preferred that the foundation models herein are trained using data that has been carefully fact-checked to start, thereby ensuring that false positives and false negatives are not incorporated into the ultimate model. This desirably avoids hallucinations. In some approaches which are in no way intended to be limiting, human experts may assess the accuracy of the outputs produced by foundation models, and perform appropriate prompting. For instance, a “chain of thought” style prompting may be implemented, e.g., as would be appreciated by one skilled in the art after reading the present description.

As mentioned above, the foundation model may optionally be configured to support additional prompts in some approaches. For instance, optional operation 310 includes adding one or more additional prompts to the foundation model. According to a non-limiting example, one or more additional prompts that are constructed to support new zero day exploits may be added to the foundation model. The foundation model may thereby be configured to handle various different attacks in a number of different situations, e.g., depending on the approach.

Referring still to FIG. 3A, method advances to operation 312, which includes causing the foundation model to build a new vulnerability chain model. The foundation model thereby produces a summation of new and novel vulnerability chain exploits that are relevant to the network and software environment that was originally surveyed by the network entity scanner. The foundation model may further be configured to supplement the vulnerability chain model with scores (e.g., EPSS, CVSS, etc., ratings) that are based at least in part on similarities to already known attack paths.

From operation 312, method 300 advances to operation 314. There, operation 314 includes sending the new vulnerability chain model to a visualizer, and causing the visualizer to convert the new vulnerability chain model into a visualization of the IT environment and identified exploit paths. The visualizer is thereby preferably configured to convert the new vulnerability chain model into the visualization based at least in part on the information associated with the IT environment collected by the network entity scanner. In some approaches, the visual representation of the new attack path model may be overlaid on known attack paths, thereby providing valuable information as to how threats change over time. This desirably allows for informed decisions to be made while performing security mitigation actions.

According to one approach, the visualizer may convert existing attack paths into graphs depicting known vulnerabilities. The visualizer may further convert the new vulnerability chain model into new or novel vulnerability graphs that are merged with the known vulnerability graphs. Furthermore, risk scores may be generated and appended to entries in the merged graphs, e.g., as would be appreciated by one skilled in the art after reading the present description.

From operation 314, method 300 advances to operation 316. There, operation 316 includes transmitting the visualization and/or base new vulnerability chain model to a user interface. In other words, operation 316 includes causing the visualization to be sent to the user interface such that the new vulnerability chain model is available for display and/or access to a user. According to an example, the visualization may be shown on a display screen while the new vulnerability chain model itself is incorporated into a processor configured to at least partially control the display screen. A user may thereby be able to access (e.g., manipulate, use, reference, etc.) the new vulnerability chain model by interacting with the display, a computer interface (e.g., keyboard, computer mouse, touchscreen, etc.), etc.

Method 300 advances from operation 316 to operation 318. There, operation 318 includes causing the AI model transformer to generate a supplemental foundation model and train the supplemental foundation model to generate runnable exploit scripts that incorporate the identified exploit paths. In other words, the supplemental foundation model is able to evaluate identified exploit paths and generate new scripts that can be run to interact with those identified paths. In some approaches, scripts may be designed (e.g., configured) to remediate one or more identified vulnerabilities. Exploit scripts may further break vulnerability chains into smaller pieces, e.g., depending on how the supplemental foundation model was/is trained.

The supplemental foundation model may be trained using training data that has been accumulated in a data lake. In some approaches, training data from a same data lake may be used to train the initial foundation model as well as the supplemental foundation model. In other approaches, each foundation model may have a respective data lake established to collect relevant training data. Moreover, the data lakes may be used to incrementally retrain the foundation models over time. Thus, the foundation models are desirably able to dynamically adjust to meet changing environments.

Depending on the approach, data lakes may include known and/or publicly disclosed cybersecurity vulnerabilities (e.g., the Common Vulnerabilities and Exposures (CVE) database), exploit predictions (e.g., Exploit Prediction Scoring System (EPSS) estimations), scripting details (e.g., programming language specific scripting details), etc. For example, the data lake may collect information corresponding to MITRE Att&ck Frameworks, CVE databases, EPSS scores, CVSS scores, scripting details for implemented programming languages, etc. Moreover, the supplemental foundation model may be trained using the IT environment information that is collected by the network entity scanner. Accordingly, in some approaches the AI model transformer may convert the new vulnerability chain model in order to create at least a portion of the supplemental foundation model.

For instance, FIG. 3C illustrates exemplary sub-operations of generating runnable exploit scripts, in accordance with one approach. It follows that one or more of these sub-operations may be performed by the AI model transformer to generate and/or train a supplemental foundation model, e.g., in response to operation 318 of FIG. 3A. However, it should be noted that the sub-operations of FIG. 3C are illustrated in accordance with one approach which is in no way intended to be limiting.

As shown, sub-operation 340 includes evaluating a received new vulnerability chain model. In other words, sub-operation 340 includes performing an intake scan on a newly generated and received vulnerability chain model. From sub-operation 340, the flowchart proceeds to sub-operation 342. There, sub-operation 342 includes generating runnable exploit scripts that incorporate the identified exploit paths. The exploit scripts may be formed using any desired programming language (e.g., PYTHON) In some approaches, sub-operation 342 further includes converting the formed exploit scripts into one or more other formats, programming languages, etc.

From sub-operation 342, difficulty ratings are generated for each exploit script. See sub-operation 344. With respect to the present description, the “difficulty ratings” are intended to summarize the creation process for the respective scripts. The generated difficulty ratings may thereby be used to further enhance risk analysis and prioritization decisions, in addition to other risk ratings. This may be achieved in some implementations by focusing on modeling a vulnerability chain from the perspective of Common Vulnerabilities and Exposures (CVE) severity, as well as exploitability in the respective IT environment. Risk scores and/or difficulty ratings may also be used to automate testing of the identified vulnerabilities, e.g., as will be described in further detail below.

Returning now to FIG. 3A, method 300 advances from operation 318 to operation 320 in response to the trained supplemental foundation model producing the new runnable exploit scripts. There, operation 320 includes passing the generated exploit scripts to a testing environment configured to run the exploit scripts. The exploit scripts may thereby be run in settings that mirror planned (e.g., known) uses cases. According to one implementation, the exploit scripts may be sent to a testing harness that is coupled to a simulated IT environment. The testing harness and/or simulated IT environment may thereby include any desired physical and/or logical components therein to produce a desired testing environment.

Moreover, operation 322 includes causing the exploit scripts to be run on the test harness. As noted above, this may be achieved by sending one or more instructions, commands, requests, executable files, etc., to the test environment (e.g., test harness) and/or a controller coupled thereto. Proceeding further to operation 324, data associated with performance of the exploit scripts is evaluated. The performance may be quantified using different types of data, e.g., such as sensor data, response times, outputs produced, etc. Moreover, the performance data may be evaluated in real-time in some approaches, allowing for dynamic changes to be made. In other approaches, the performance data may be collected and evaluated at least some time after the exploit scripts have been run. Thus, the performance data may be collected and/or evaluated periodically, in response to receiving a request, in response to a predetermined condition being met, etc.

Evaluating the performance data allows for each related vulnerability to be tested in a desired environment. Thus, operation 326 further includes making changes to the IT environment being evaluated, the exploit scripts themselves, retraining one or more of the foundation models, using the foundation models to generate additional outputs, etc. In other words, operation 326 includes proactively acting on any issues that are identified as a result of performing the testing and evaluating the results. It follows these changes may be based at least in part on the evaluation performed in operation 324.

It follows that approaches herein develop and utilize generative AI during the identification, assessment, and risk rating of multiple different chained vulnerabilities. Furthermore, trained models are able to generate exploit scripts based on these identified vulnerabilities. For instance, approaches herein implement foundation models configured to identify and grade various vulnerability chains, in addition to discovering new vulnerability chains that are not commonly known (e.g., not classified in current taxonomies). Approaches herein also use an appropriately trained foundation model to automate the generation of exploit scripts based on these vulnerability chains, and give each a difficulty rating to enhance existing risk scores to enhance remediation prioritization.

Again, foundation models herein may be on exploit taxonomies, CVE data, knowledge of specific IT environments, etc., in order to identify new and novel paths that are not already classified as well as generate exploit scripts based on these paths. For example, one or more large language models (LLMs) may be used to explain the output of graphical relationships illustrating attack paths. Foundation models herein may focus on the likelihood of exploitation of an entire chain of linked vulnerabilities, as opposed to an individual vulnerability. Some approaches use specific risk scores, but the probability of exploitation is preferably assessed based on the entire linked chain.

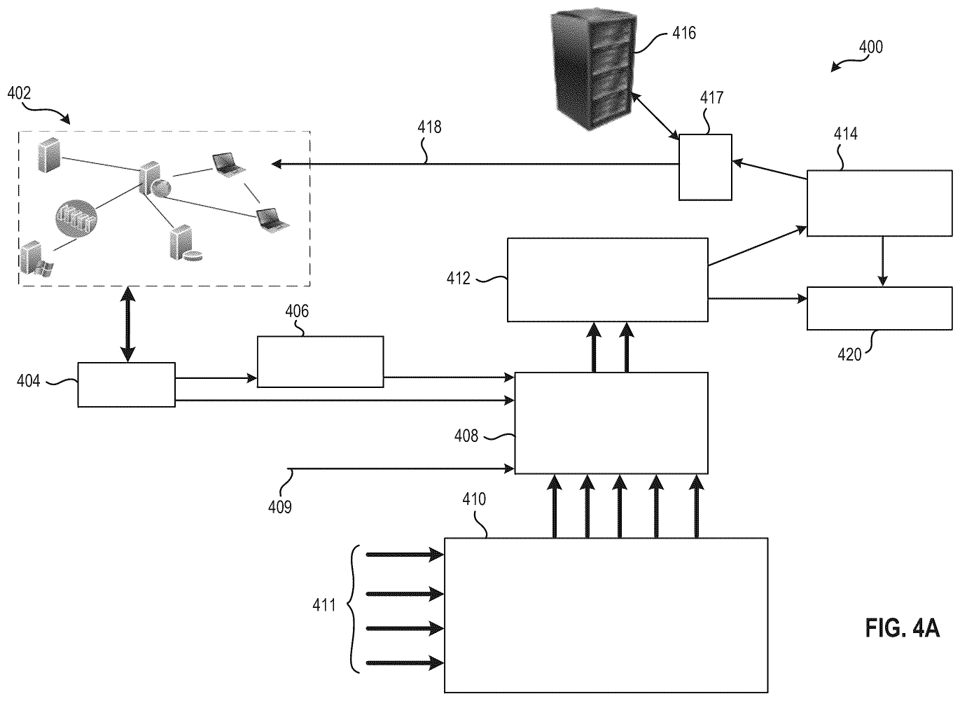

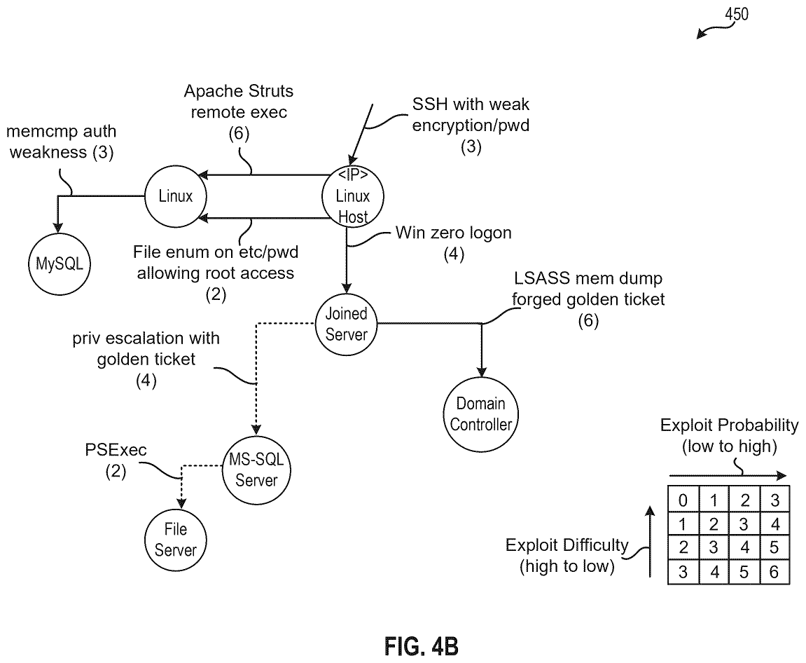

Looking now to FIG. 4A, a system 400 having a distributed architecture is illustrated in accordance with one approach. As an option, the present system 400 may be implemented in conjunction with features from any other approach listed herein, such as those described with reference to the other FIGS., such as FIG. 2. However, such system 400 and others presented herein may be used in various applications and/or in permutations which may or may not be specifically described in the illustrative approaches or implementations listed herein. Further, the system 400 presented herein may be used in any desired environment. Thus FIG. 4A (and the other FIGS.) may be deemed to include any possible permutation.

As shown, the system 400 includes an IT environment 402 with a number of components included therein. As shown, the components are connected to each other and are preferably able to communicate with each other. For example, the components in the IT environment 402 may be connected to a same network, and may thereby be positioned in different geographical locations. The network may be of any type, e.g., depending on the desired approach.

As shown, the network entity scanner 404 is used to scan the IT environment 402. According to some approaches, the network entity scanner 404 includes a vulnerability scanner that is able to identify and interpret the various logical and physical connections that exist between the various components in the IT environment 402. Moreover, the network entity scanner 404 is also preferably able to identify changes in the IT environment 402 as they occur by evaluating performance data in real-time.

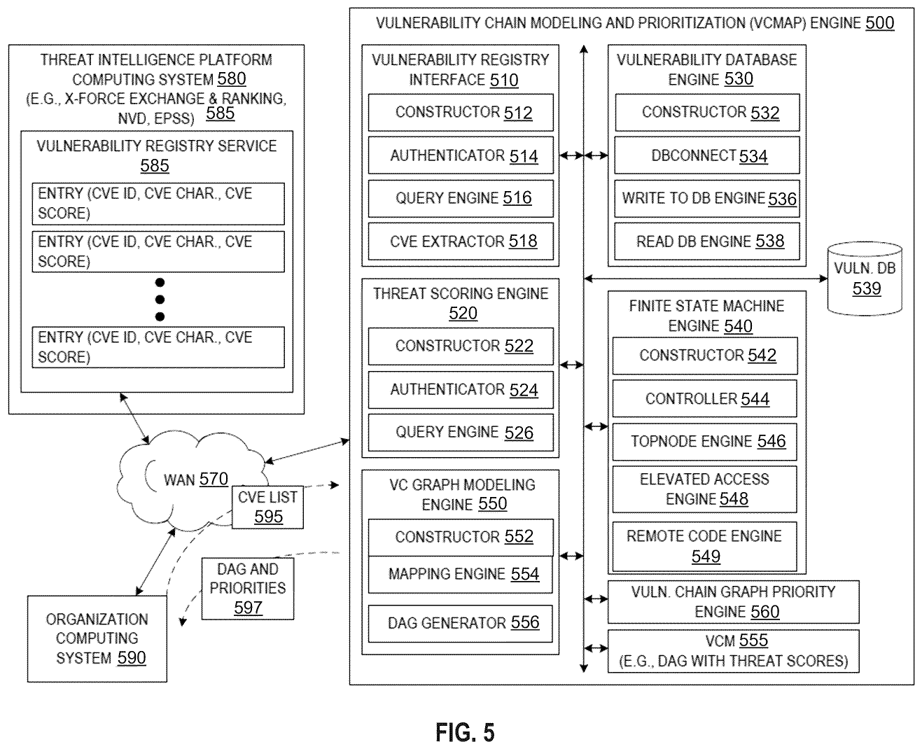

The information collected from the IT environment by the network entity scanner 404 is sent to a chained vulnerability identifier 406 as well as the data trainer 408. Other prompts and/or other labelled data 409 (e.g., new zero day exploit discovery) may also be provided to the data trainer 408. The chained vulnerability identifier 406 is preferably configured to enumerate and prioritize the severity of existing vulnerability chains. To do this, the chained vulnerability identifier examines the vulnerabilities, and based on their characteristics, subsets of those vulnerabilities will be “linked” together to form vulnerability chains. Vulnerability chains can further be prioritized to show appeal of exploitation from the perspective of a bad actor. Accordingly, the chained vulnerability identifier 406 may further be configured to link corresponding subsets of the identified vulnerabilities to form the vulnerability chains. In some approaches, the chained vulnerability identifier illustrated in FIG. 5 may be implemented in FIG. 4A.

With continued reference to FIG. 4A, the chained vulnerability identifier 406 produces vulnerability chains that are also provided to the data trainer 408. The data trainer 408 thereby has access to a variety of information associated with the IT environment 402. Data trainer 408 also has access to a variety of training data 411 that has been stored in data lake 410. For example, the data lake 410 may include information corresponding to MITRE Att&ck Frameworks, CVE databases, EPSS scores, CVSS scores, scripting details for implemented programming languages, etc. The data trainer 408 may thereby be able to generate and/or transform an AI based model. For instance, the data trainer 408 may be able to generate and/or train foundation models using the IT environment information that is collected by the network entity scanner.

Accordingly, the data trainer 408 and/or foundation models produced thereby may be used to form the new vulnerability chain model 412. The vulnerability chain model 412 is further evaluated by a supplemental foundation model 414. As noted above, the supplemental foundation model may be trained to generate runnable exploit scripts that incorporate exploit paths identified in the IT environment 402. In other words, the supplemental foundation model 414 is able to evaluate identified exploit paths and generate new scripts that can be run (e.g., performed) to interact with those identified paths. In some approaches, scripts may be designed (e.g., configured) to remediate one or more identified vulnerabilities. Exploit scripts may further break vulnerability chains into smaller pieces, e.g., depending on how the supplemental foundation model was/is trained.

For instance, the supplemental foundation model 414 is shown as having access to a virtual testing environment 416 and corresponding testing harness 417. The testing environment 416 may be a Pen testing environment in some approaches, and is preferably configured to run the generated exploit scripts. Moreover, the testing environment 416 may be configured according to a particular configuration of components, base programming language, operating system, etc. As described above, the supplemental foundation model 414 may orchestrate the testing that is performed at the testing environment 416.

Results of implementing the generated scripts at the testing environment 416 may be used to update one or more settings, configurations, components, applications, etc., that are implemented in the IT environment 402. See 418. For example, the supplemental foundation model 414 may generate one or more instructions that cause changes to be implemented in the IT environment 402. The supplemental foundation model 414 also generates difficulty ratings for each of the generated scripts. These difficulty ratings may thereby be sent to visualizer 420. Moreover, the visualizer 420 is preferably configured to convert the new vulnerability chain model 412 into a visualization of the IT environment and identified exploit paths. The visualizer is thereby preferably configured to convert the new vulnerability chain model into the visualization based at least in part on the information associated with the IT environment collected by the network entity scanner 404. In some approaches, the visual representation of the new attack path model may be overlaid on known attack paths, thereby providing valuable information as to how threats change over time. This desirably allows for informed decisions to be made while performing security mitigation actions.

According to one approach, the visualizer may convert existing attack paths into graphs depicting known vulnerabilities. The visualizer may further convert the new vulnerability chain model into new or novel vulnerability graphs that are merged with the known vulnerability graphs. Furthermore, risk scores may be generated and appended to entries in the merged graphs, e.g., as would be appreciated by one skilled in the art after reading the present description.

Referring now to FIG. 4B, a new vulnerability chain model 450 is shown in accordance with an in-use example. The nodes represent example hosts in a computer system and the arrows represent different example vulnerabilities present on those hosts, as well as their related configuration and software. The numbers attached to the arrows represent a difficulty or risk rating for that respective vulnerability, based at least in part on the example grid in the bottom right-hand corner. For example, in the case of the LSASS memory dump vulnerability, this is rated as 6 as it is relatively difficult to exploit, in that it takes specific skill and knowledge, but it is also highly likely to be exploited due to the fact it has a high value outcome (potentially all the credentials in the domain), has been known for some time and has modules written for it in popular hacking tools such as METASPLOIT. As an option, the present vulnerability chain model 450 may be implemented in conjunction with features from any other approach listed herein, such as those described with reference to the other FIGS., such as FIG. 4A.

The initial input related to an IT system being evaluated may include a given set of vulnerability reports and/or a list of domains (e.g., IP CIDR ranges) to be scanned. In situations where domains are supplied, the system preferably executes a vulnerability scan and port scan for the domains and/or ranges that are provided. Scanned data may thereby be aggregated and forwarded to a chained vulnerability identifier component as described herein.

For instance, the chained vulnerability identifier component is able to identify existing (e.g., known and already classified) vulnerability chains. The chained vulnerability identifier component also utilizes information including live IP addresses, their associated vulnerabilities and misconfigurations, etc., certain vulnerabilities will be “linked” together to form vulnerability chains. Depending on the approach, these links may be formed based on vulnerability characteristics such as: attack vector, impact on Confidentiality, Integrity, Availability (CIA) triad, and consequence of exploitation. The model output may thereby be provided to a data trainer to evaluate for vulnerability chains and related risk scores. As shown in the in-use example of FIG. 4B, the solid lines correspond to known vulnerability chains, while the dashed lines correspond to newly identified vulnerability chains. Each node also includes a relative difficulty score that incorporates both the difficulty of creating the corresponding exploit code, as well as the probability the given code will be taken advantage of (e.g., exploited).

It follows that approaches herein are desirably able to develop system configured to detect, identify, and grade new (not previously classified) chained vulnerability exploits in an IT environment. Instead of identifying already classified vulnerability chains (such as those that can be derived from taxonomies), the approaches herein identify new or novel vulnerability chains, giving each an individual weighting, based on ease and likelihood of exploitation (such as EPSS or CVSS), and shows a simple graphical representation of the path and steps at each point.

It follows that approaches herein train a system on a variety of input data, scans a given IT environment (or works from a recent vulnerability scan or pen test of the environment), and identify new or novel chained vulnerabilities based on the evaluation. This is achieved at least in part by implementing foundation models that have been trained to have ‘emergent behaviors’, that allow for new connections to be made based on the data it is trained with. Foundation models herein are thereby able to predict how a new or novel attack might progress and differentiate this relative to known vulnerability paths.

Approaches herein are also able to generate exploit scripts for each identified vulnerability chain. In other words, some approaches include a system configured to write sample scripts that exploit a given chained vulnerability in an IT environment. In addition to generating original scripts, an individual difficulty weighting may also be generated and assigned to the respective scripts. As noted above, these difficulty weighting may be based on ease of exploitation (e.g., how easy it is to write the script to do this) which can be used to enhance an existing vulnerability score for a vulnerability chain.

Again, approaches herein are desirably able to detect, identify, and grade vulnerability chains in IT environment with less compute overhead than conventionally achievable. Approaches herein are thereby able to achieve greater throughput. This means better coverage and that such a system may be directed to risk management and/or implementing practical mitigations more often than conventionally achievable.

As noted above, FIG. 5 is an example block diagram illustrating the operational components of a chained vulnerability identifier (also referred to herein as a VCMAP engine) in accordance with one illustrative approach.

As shown, the VCMAP engine 500 includes a vulnerability registry interface 510, a threat scoring engine 520, a vulnerability database engine 530, a finite state machine engine 540, a vulnerability chain graph modeling engine 550 that includes a constructor 552, a mapping engine 554, and a Directed Acyclic Graph (DAG) generator 556. The vulnerability chain graph modeling engine 550 also generates a learned vulnerability chain model (VCM) 555, and a vulnerability chain graph prioritization engine 560. The VCMAP engine 500 may access Common Vulnerabilities and Exposure (CVE) entries of a vulnerability registry service computing system 585, of a threat intelligence platform computing system 580, e.g., IBM® X-Force®, via one or more data networks 570. The VCMAP engine 500 may receive a list of CVEs 595 for an organization's computing system 590 and may execute the learned VCM 555 on the list of CVEs 595 to generate a graph representation 597 of the organization's vulnerability chains and prioritization of these vulnerability chains for remedial actions and resource allocation.

The vulnerability registry interface 510 may implement computer executable logic that operates to pull down a list of all CVEs, as well as CVE characteristics, such as attack vector and impact on CIA triad, from the vulnerability registry service computing system 580. In some illustrative approaches, the logic of the vulnerability registry interface 510 may implement a constructor 512, an authenticator 514, a query engine 516, and a CVE extractor 518. These elements may be implemented as methods, for example, as follows.

The constructor 512 comprises logic that is used to instantiate a threat intelligence platform, such as a class that comprises methods for pulling down the list of CVEs, CVE characteristics, and the like, as well as define the variables named headers and base_url. The variable named headers represents the header metadata, e.g., the HTTP authorization header, used to execute requests, e.g., GET requests, against the Exchange Application Programming Interface (API). The variable named base_url represents the base, or root Uniform Resource Locator (URL) used to make API calls, e.g., Representational State Transfer (REST) API calls.

The authenticator 514 may comprise logic, such as a private method named “authenticate”, which is used to authenticate the VCMAP engine 500 with the threat intelligence platform. For example, this method may read in an exchange API key and password which are stored as environment variables. The method returns a decoded authentication key provided by the API, e.g., a base 64 decoded authentication key.

The query engine 516 comprises logic, such as a method called “apiQuery”, which is used to handle pagination and execute GET requests against the threat intelligence platform API. The API may receive a string representation of a time stamp that is passed in the initial API call. The API returns all vulnerabilities disclosed before the date of the time stamp. In some illustrative approaches, a hardcoded timestamp, e.g., 1970-01-01T00:00:00Z, is provided to designate the date that the vulnerability was discovered and made public.

The CVE extractor 518 comprises logic, such as a private method called “parseOutput” that operates to parse the received data frame and extract the CVE characteristics. For example, the parseOutput method may receive raw JavaScript Object Notation (JSON) data that is returned from a GET request and can parse the data to extract CVE characteristics.

The threat scoring engine 520 comprises logic, such as a “ThreatScore” class. In some illustrative approaches, the threat scoring engine 520 comprises a constructor 522, an authenticator 524, and a query engine 526. In some illustrative approaches, these elements of the threat scoring engine 520 may be implemented as methods of the ThreatScore class. For example, the constructor 522 may be implemented as a method used to instantiate the ThreatScore class as well as define the variables named base_url and headers, similar to the constructor 512 of the vulnerability registry interface 510. In this case, the variable named headers represents the HTTP authorization header used to execute GET requests against the ThreatScore API. The variable named base_url represents the base, or root URL, used to make REST API calls.

The authenticator 524 comprises logic, such as a private method named “authenticate”, that is used to authenticate the VCMAP engine 500 with the ThreatScore REST API. The authenticate method reads in the ThreatScore API key and regID which are stored as environment variables. The authenticate method returns an authentication key provided by the API.

The query engine 526 comprises logic, such as a method named “Query”, that is responsible for handling pagination and executing GET requests against the ThreatScore API. The method returns a data frame containing all CVEs, their threat score, or CVE score from the entries in the vulnerability registry service 585, and consequences of exploitation, with this information being obtained from the vulnerability registry service 585 of the threat intelligence platform computing system 580.

The vulnerability database engine 530 comprises logic, such as a “Database” class, that is used to store and retrieve the final results retrieved from the vulnerability registry interface 510 and threat scoring engine 520, e.g., from the Exchange and ThreatScore classes mentioned above, within a vulnerability database 539, such as a MySQL database. In some illustrative approaches, the vulnerability database engine 530 comprises a constructor 532, database connect engine 534, a write to database engine 536, and a read database engine 538.

The write to database engine 536 comprises logic, such as a method called “writeToDatabase”, which receives the final output from the vulnerability registry interface 510 and threat scoring engine 520, e.g., the Exchange and ThreatScore classes, and writes it to the vulnerability database 539. The read database engine 538 comprises logic, such as a method called “readFromDatabase”, that reads a table from the vulnerability database 539. This “readFromDatabase” method is used to read the threat score and CVE information, e.g., the ThreatScore and Exchange API information, from the vulnerability database 539.

The finite state machine (FSM) 540 comprises logic, such as an FSM class, used to represent a finite state machine. This finite state machine is responsible for creating a Dynamic Acyclic Graph (DAG) from a linked list, determining the position of each node within the DAG, and setting the value of each of the edges of the graph based on the aggregated risk score of the two nodes connected by that edge. The FSM 540 comprises a constructor 542, a controller 544, a top node engine 546, an elevated access engine 548, and a remote code engine 549.

The controller 544 comprises logic, such as a method called “controller”, that handles the transitions between states and checks for a final state. When a final state is detected, the controller method takes the final state, which is a DAG, and assigns the value to the dag variable that is instantiated by the constructor 542.

The top node engine 546 comprises logic, such as a method called “topNode”, that checks whether a given vulnerability would provide an attacker with minimal access to a system that could allow them to gain an initial foothold. This topNode method checks for vulnerabilities that would represent the first link in a vulnerability chain, i.e., vulnerability chain initial vulnerabilities. These checks may look at vulnerability characteristics, such as attack vector, impact on CIA triad, and consequence of exploitation, and apply rules/logic to determine whether a vulnerability has characteristics indicative of an initial vulnerability in a vulnerability chain.

The elevated access engine 548 comprises logic, such as a method called “isElevatedAccess”, that checks whether a given vulnerability would provide an attacker with the ability to either escalate privileges on a system or exfiltrate data that would allow them to either further compromise a system or execute arbitrary code on a system, i.e., elevated access vulnerabilities.

The remote code engine 549 comprises logic, such as a method called “isCodeExec”, which checks whether a given vulnerability allows for authenticate or unauthenticated remote code execution, i.e., remote code vulnerabilities.

It will be clear that the various features of the foregoing systems and/or methodologies may be combined in any way, creating a plurality of combinations from the descriptions presented above.

It will be further appreciated that implementations of the present invention may be provided in the form of a service deployed on behalf of a customer to offer service on demand.

The descriptions of the various implementations of the present invention have been presented for purposes of illustration, but are not intended to be exhaustive or limited to the implementations disclosed. Many modifications and variations will be apparent to those of ordinary skill in the art without departing from the scope and spirit of the described implementations. The terminology used herein was chosen to best explain the principles of the implementations, the practical application or technical improvement over technologies found in the marketplace, or to enable others of ordinary skill in the art to understand the implementations disclosed herein.

What is claimed is:

1. A computer-implemented method (CIM), comprising:
causing a network entity scanner to scan an Information Technology (IT) environment and collect information associated with the IT environment;
causing a chained vulnerability identifier to identify vulnerability chains based at least in part on the IT environment information;
causing a foundation model to build a new vulnerability chain model, wherein the foundation model is trained on the IT environment information and the vulnerability chains;
causing a visualizer to convert the new vulnerability chain model into a visualization of the IT environment and identified exploit paths; and
transmitting the visualization to a user interface.

2. The CIM of claim 1, further comprising:
causing a supplemental foundation model to:
evaluate the new vulnerability chain model, and
generate runnable exploit scripts that incorporate the identified exploit paths.

3. The CIM of claim 2, wherein the supplemental foundation model is trained using training data in a data lake, the training data being selected from the group consisting of: cybersecurity vulnerabilities, exploit predictions, and scripting details.

4. The CIM of claim 2, further comprising:
passing the generated exploit scripts to a test harness attached to a simulated IT environment;
causing the exploit scripts to be run on the test harness; and
evaluating performance of the exploit scripts.

5. The CIM of claim 2, wherein the supplemental foundation model is configured to generate a difficulty rating for each exploit script.

6. The CIM of claim 1, further comprising:
adding one or more additional prompts to the foundation model, wherein the additional prompt(s) are configured to support zero day exploits.

7. The CIM of claim 1, wherein the visualizer is configured to convert the new vulnerability chain model into the visualization based at least in part on the information associated with the IT environment collected by the network entity scanner.

8. The CIM of claim 1, wherein the chained vulnerability identifier is configured to identify vulnerability chains by:
examining the IT environment information;
identifying vulnerabilities in the IT environment information; and
linking subsets of the identified vulnerabilities to form the vulnerability chains.

9. A computer program product (CPP), comprising:
a set of one or more computer-readable storage media; and
program instructions, collectively stored in the set of one or more storage media, for causing a processor set to perform the following computer operations:
cause a network entity scanner to scan an Information Technology (IT) environment and collect information associated with the IT environment;
cause a chained vulnerability identifier to identify vulnerability chains based at least in part on the IT environment information;
cause a foundation model to build a new vulnerability chain model, wherein the foundation model is trained on the IT environment information and the vulnerability chains;
cause a visualizer to convert the new vulnerability chain model into a visualization of the IT environment and identified exploit paths; and
transmit the visualization to a user interface.

10. The CPP of claim 9, wherein the program instructions are for causing the processor set to further perform the following computer operations:
cause a supplemental foundation model to:
evaluate the new vulnerability chain model, and
generate runnable exploit scripts that incorporate the identified exploit paths.

11. The CPP of claim 10, wherein the supplemental foundation model is trained using training data in a data lake, the training data being selected from the group consisting of: cybersecurity vulnerabilities, exploit predictions, and scripting details.

12. The CPP of claim 10, wherein the program instructions are for causing the processor set to further perform the following computer operations:
pass the generated exploit scripts to a test harness attached to a simulated IT environment;
cause the exploit scripts to be run on the test harness; and
evaluate performance of the exploit scripts.

13. The CPP of claim 10, wherein the supplemental foundation model is configured to generate a difficulty rating for each exploit script.

14. The CPP of claim 9, wherein the program instructions are for causing the processor set to further perform the following computer operations:
add one or more additional prompts to the foundation model, wherein the additional prompt(s) are configured to support zero day exploits.

15. The CPP of claim 9, wherein the visualizer is configured to convert the new vulnerability chain model into the visualization based at least in part on the information associated with the IT environment collected by the network entity scanner.

16. The CPP of claim 9, wherein the chained vulnerability identifier is configured to identify vulnerability chains by:
examining the IT environment information;
identifying vulnerabilities in the IT environment information; and
linking subsets of the identified vulnerabilities to form the vulnerability chains.

17. A computer system (CS), comprising:
a processor set;
a set of one or more computer-readable storage media;
program instructions, collectively stored in the set of one or more storage media, for causing the processor set to perform the following computer operations:
cause a network entity scanner to scan an Information Technology (IT) environment and collect information associated with the IT environment;
cause a chained vulnerability identifier to identify vulnerability chains based at least in part on the IT environment information;
cause a foundation model to build a new vulnerability chain model, wherein the foundation model is trained on the IT environment information and the vulnerability chains;
cause a visualizer to convert the new vulnerability chain model into a visualization of the IT environment and identified exploit paths; and
transmit the visualization to a user interface.

18. The CS of claim 17, wherein the program instructions are for causing the processor set to further perform the following computer operations:
cause a supplemental foundation model to:
evaluate the new vulnerability chain model, and
generate runnable exploit scripts that incorporate the identified exploit paths.

19. The CS of claim 18, wherein the supplemental foundation model is trained using training data in a data lake, the training data being selected from the group consisting of: cybersecurity vulnerabilities, exploit predictions, and scripting details.

20. The CS of claim 18, wherein the program instructions are for causing the processor set to further perform the following computer operations:
pass the generated exploit scripts to a test harness attached to a simulated IT environment;
cause the exploit scripts to be run on the test harness; and
evaluate performance of the exploit scripts.
